(19) United States
(12) Patent Application Publication
(10) Pub. No.: US 2004/0215644 A1
(43) Pub. Date: Oct. 28, 2004

(54) Apparatus, method, and system for aggregated no query restore

(76) Inventors: Robert Clair Edwards JR., Susquehanna, PA (US); Barry Fruchtman, Tucson, AZ (US); Omar Bond Vargas, Port Orange, FL (US)

Correspondence Address: KUNZLER & ASSOCIATES, 8 EAST BROADWAY, SUITE 600, SALT LAKE CITY, UT, 84111, US

(21) Appl. No.: 10/846,880

(22) Filed: May 14, 2004

Related U.S. Application Data
(63) Continuation-in-part of application No. 10/091,797, filed on Mar. 6, 2002.

(51) Int. Cl. G06F 7/00

(52) U.S. Cl. 707/100

(57) ABSTRACT

An apparatus, method, and system to restore data from a networked storage pool where a storage agent requests information pertaining to data objects that are associated with a data restore. A storage server responds by querying a storage database to find metadata corresponding to the restore objects, combines the metadata into a packet, and sends the packet to the requester. The storage agent receives the packet which contains an aggregation of information corresponding to the data objects. The storage agent uses the information to send data to a client to copy the data objects to a restore volume and restore attributes such as a file name and access rights. Aggregating the information reduces network traffic and decreases the time necessary to perform the data restore operation.

### CROSS-REFERENCES TO RELATED APPLICATIONS

This application is a continuation-in-part of and claims priority to U.S. Pat. application Ser. No. 10/091,797 entitled “Multi-Session No Query Restore” and filed on Mar. 6, 2002 for Robert Edwards, Barry Fruchtman, and Omar Vargas, which is incorporated herein by reference.

### BACKGROUND OF THE INVENTION

1. Field of the Invention

This invention relates to data restoration in a networked computing environment and more particularly relates to data restoration in a networked computing environment in which a client system receives information relating to stored objects from a storage server.

2. Description of the Related Art

Data is the underlying resource on which most computing processes are based. Many businesses use personal computers (PCs) arranged in a client/server network to process the data. A PC and associated software often function as a client, and request a system service or data object from a server. The server responds to the request and supplies the requested data object or service to the client. Clients and servers on such a network often communicate over an associated local area network (LAN). In a client/server system with multiple clients incorporating a large database, the volume of storage-related transfers on the network may consume a large portion of the network bandwidth.

Storage area networks (SANs) have emerged to provide a complementary network with access to shared data without the need to use LAN bandwidth for transmission of data. Furthermore, SANs typically provide storage services such as backup and restoration functions to clients and/or client systems. A SAN is a dedicated network separate from LANs and wide area networks (WANs) that interconnects clients and/or client systems to one or more storage servers and multiple storage devices.

Data storage devices store and retrieve data on a long-term basis. A typical storage device includes some type of recording medium that physically stores data and a reader that retrieves the data upon request. Examples of storage devices include magnetic tape, optical disks, magnetic hard disks, and floppy disks. Storage devices can be arranged in a variety of configurations, including a redundant array of independent disks (RAID). Such a RAID array often functions as a storage device connected to a SAN. SANs often use high interconnect data rates (gigabits/second) to communicate with member storage devices. SANs, like LANs and WANs, can be interconnected using routers, hubs, switches, gateways, and the like. A SAN may be local or extend over geographic distances.

A client does not typically maintain directories necessary to locate all data objects backed up on the shared data storage devices connected to the SAN. Instead, one or more storage management servers often maintain information on data objects in a storage database that were previously backed-up or archived with the storage management server. The information pertaining to backed-up or archived data objects is referred to as metadata. Typical metadata includes the size of the data object, identification of the physical volume that contains the object, location of the object within the volume, sharing attributes of the object, and so forth.

In such systems, client computers often access backed-up data on the SAN using a program called a storage agent. The storage agent acts as a local representative of the server to the client, permitting the client to access backed-up data objects on the SAN as if the objects were on a local data base. The storage agent may interrogate the storage database maintained on the storage server using a remote query to determine metadata necessary to locate an object within a storage pool, access the server storage, and hand off the appropriate data to the client restore program. Many remote queries are necessary to access a single data object. The remote interrogation of the storage database by the storage agent is typically performed over the LAN.

In a data restore operation, attributes corresponding to all of the objects associated with the restore must be determined. In the prior art, a storage agent performs remote queries on the storage database to obtain the object attributes. Since the data restore involves multiple remote queries for each of the many objects involved in the restore, the volume of database queries and network traffic generated by the restore often significantly degrade the performance of the networked system.

A need exists for a method, apparatus, and system that reduces the performance degradation during data restoration in a SAN environment. Beneficially, such a method, system and apparatus would reduce the amount of network traffic during a data restore and decrease the time necessary to restore the data.

### SUMMARY OF THE INVENTION

The present invention has been developed in response to the present state of the art, and in particular, in response to the problems and needs in the art that have not yet been fully solved by currently available systems for restoring data from a networked storage pool. Accordingly, the present invention has been developed to provide a method, apparatus, and system for restoring data from a networked storage pool that overcome many or all of the above-discussed shortcomings in the art.

The apparatus for restoring data from a networked storage pool is provided with a logic unit containing a plurality of modules configured to functionally execute the necessary steps of for restoring data from a networked storage pool. These modules in the described embodiments include a query module and a restore module.

In one embodiment, the apparatus for restoring data from a networked storage pool, is configured to request information regarding data objects associated with a restore, to receive metadata aggregated from queries to a storage database corresponding to the data objects, and to restore the data objects from a storage pool to a client's restore volume. In one embodiment, the request specifies a particular restore session and references a particular volume. The information request, in one embodiment, is received and serviced by a storage server, the server performing multiple queries to a storage database and sending one or more batches of information associated with multiple data objects to the requester.

The apparatus for providing metadata from a storage database is also provided with a logic unit containing a plurality of modules configured to functionally execute the necessary steps for providing metadata from a storage database. These modules in the described embodiments include a search module and a results module.

In one embodiment, the apparatus for providing metadata from a storage database is configured to receive a query request and search a storage database for information regarding multiple data objects associated with the query request, and to aggregate and send one or more batches of the information associated with the data objects to the requester. In one embodiment, the information associated with a data object is metadata such as location of the object on the storage media, name of the object, size of the object, access rights to the object, and the like.

A system of the present invention is also presented for restoring data from a networked storage pool. The system may be embodied with a local area network (LAN), a storage area network (SAN), one or more client computers connected to the LAN and the SAN, and a storage pool with one or more storage devices connected to the SAN. In one embodiment, a storage agent queries a storage server regarding objects associated with a data restore and the storage server responds by providing batches of metadata corresponding to objects stored in the storage pool, the metadata aggregated from searches of a storage database.

A method of the present invention is also presented for restoring data from a networked storage pool. The method in the disclosed embodiments substantially includes the steps necessary to carry out the functions presented above with respect to the operation of the described apparatus and system. In one embodiment, the method includes requesting information regarding objects associated with a data restore, receiving metadata aggregated from multiple searches to a storage database corresponding to the data objects, and transferring data relating to the objects from a storage pool to a client for placement on a restore volume.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for restoring data from a networked storage pool of the present invention;

FIG. 2 is a schematic block diagram illustrating one embodiment of an apparatus for restoring data from a networked storage pool of the present invention;

FIG. 3 is a schematic block diagram illustrating one embodiment of an apparatus for providing metadata from a storage database of the present invention; and

FIG. 4 is a schematic flow chart diagram illustrating one embodiment of a method for restoring data from a networked storage pool of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present invention may be embodied in a networked storage environment wherein a storage database is maintained to track attributes of backed-up data objects stored in a storage pool. To restore data from the storage pool, the storage database is queried to determine information pertaining to all the data objects related to the restore. This information, referred to as metadata, is then communicated to the storage agent. The storage agent copies the data from the storage pool and transmits the data to the client restore program, which uses the metadata to restore the data and reconstruct the directory.

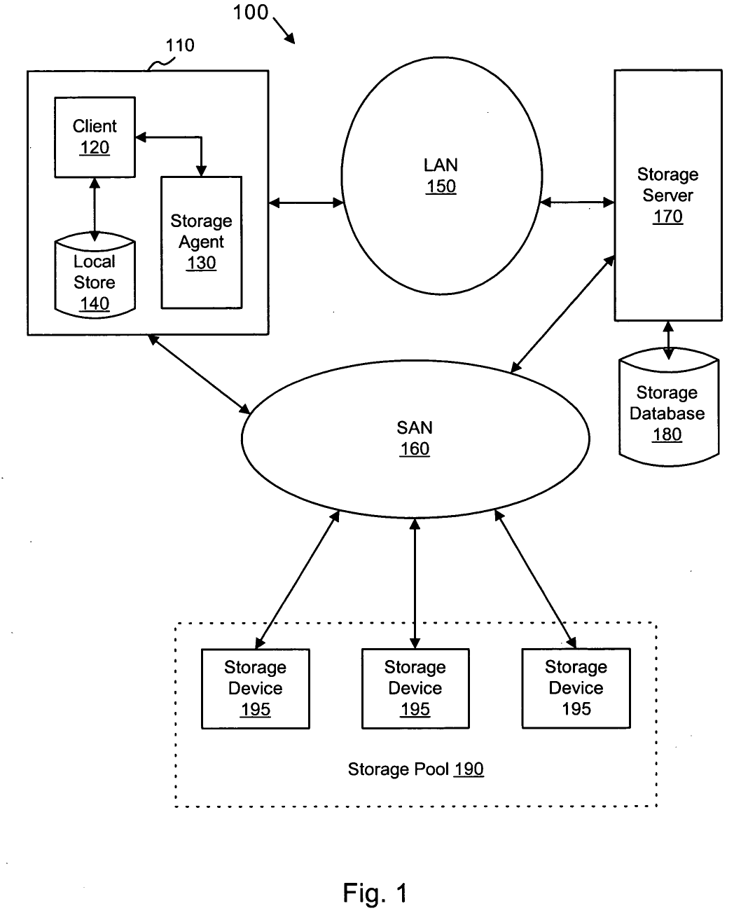

FIG. 1 depicts a schematic block diagram illustrating one embodiment of a system for restoring data from a networked storage pool of the present invention. The computer network system 100 includes a client system 110 containing a client 120, a storage agent 130, and a local data store 140. Each client may be a PC or software on the PC. Although only one client is shown, those skilled in the art will recognize that the client system 110 may contain any number of clients 120.

The storage agent 130 is a software module that enables the client 120 to communicate data to and from a storage pool 190 directly over a storage area network (SAN) 160. The storage agent 130 may be shared among multiple clients 120 within the client system 110. The client system 110 is connected to a local area network (LAN) 150 and the SAN 160. Although only one client system 110 is shown, those skilled in the art will recognize that a computer network system 100 consistent with the invention may contain multiple LANs 150 and SANs 160 as well as any number of client systems 110.

The computer network system 100 also includes a storage server 170 connected to the LAN 150 and the SAN 160. The storage server 170 maintains a storage database 180 wherein attributes of data objects stored in the storage pool 190 are recorded. The storage database 180 may be directly connected to the storage server 170 or may be accessed by using the SAN 160.

The storage pool 190 includes a plurality of storage devices 195. Any number of the storage devices 195 may be present in a computer network system 100 consistent with the invention. Each storage device 195 includes a storage medium which physically stores data, such as magnetic tape, optical media, rigid magnetic disk, and the like. The storage pool 195 may include multiple storage device types with differing access methods, including storage devices used primarily for archiving data.

Data transfers between the client system 110 and the storage pool 190 normally occur using the direct connection to the SAN 160, without moving the data through the LAN 150 or the storage server 170. Accordingly, the bandwidth of the LAN 150 may be used for other purposes and the storage server 170 may support a greater number of simultaneous client connections. The client systems 110 may continue to use the LAN 150 to exchange control information with the storage server 170 such as policy information and metadata regarding objects in the storage pool. As data from each client 120 on each client system 110 is stored in one or more of the storage devices 195 of the storage pool 190, the storage server 170 receives information indicating the stored location of the object, and other object attributes. The storage server 170 records the information in the storage database 180.

At the time a client 120 requests a data restore, the storage server 170 identifies one or more volumes in the storage pool associated with that particular restore request. The storage agent 130 requests information regarding the plurality of objects associated with a particular restore. The storage server 170 may also perform multiple queries against the storage database 180 to retrieve metadata regarding the restore objects. The storage server 170 aggregates the metadata corresponding to a plurality of objects and sends a batch of metadata to the storage agent 130. Multiple batches of metadata may be required to communicate the information associated with all of the restore objects. Multiple clients 120 and multiple storage agents 130 may participate in the restore.

The storage agent 130 uses the metadata received from the storage server 170 to transfer the data objects from the storage pool 190 to the client 120 for placement on the local data store 140 or other restore volume. The searching of the storage database 180, the transferring of batches of metadata, and the transferring of data from the storage pool 190 to a restore volume may occur simultaneously until all the objects associated with a particular restore have been written to the restore volume. Transferring object information in batches reduces the LAN 150 communication bandwidth, decreases the time that the storage agent 130 is idle while waiting for a response to a remote database query, and reduces the time required to perform the restore.

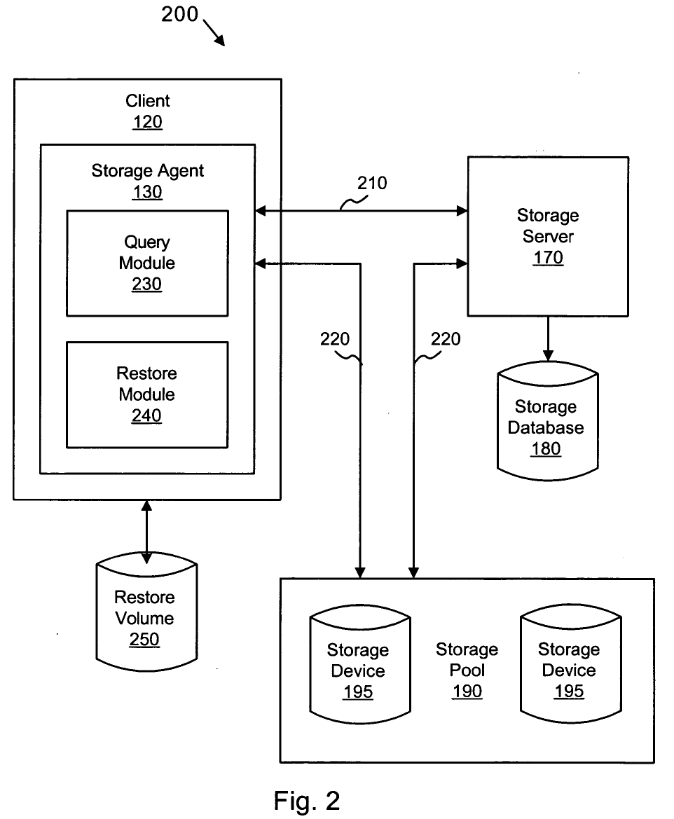

FIG. 2 depicts a schematic block diagram illustrating one embodiment of an apparatus for restoring data from a networked storage pool of the present invention. A networked environment 200 includes a storage agent 130 that is a software module that enables a client 120 to communicate data directly to and from the storage pool 190 by a SAN 160 (of FIG. 1). The storage agent 130 is connected to a storage server 170 by a LAN connection 210 and to a storage pool 190 by a SAN connection 220. The storage agent includes a query module 230 and a restore module 240.

The query module 230 requests information via the LAN connection 210 from the storage server 170 regarding objects associated with a data restore. The query module 230 further receives batches of metadata corresponding to one or more of the objects, the metadata aggregated from searches of a storage database 180 maintained by the storage server 170. The restore module transfers data objects corresponding to the metadata from a storage device 195 in the storage pool 190 to the client 120, and the client 120 sends the data objects to a restore volume 250 using the SAN connection 220.

The requesting of information from the query module 230, the searching of the storage database 180, the sending of batches of metadata to the query module 230, and the restoring of data from the storage pool 190 to the restore volume 250 may be performed simultaneously until the restore is complete. Communicating the metadata in batches permits more efficient utilization of the LAN 150 and decreases the time required to perform the data restore.

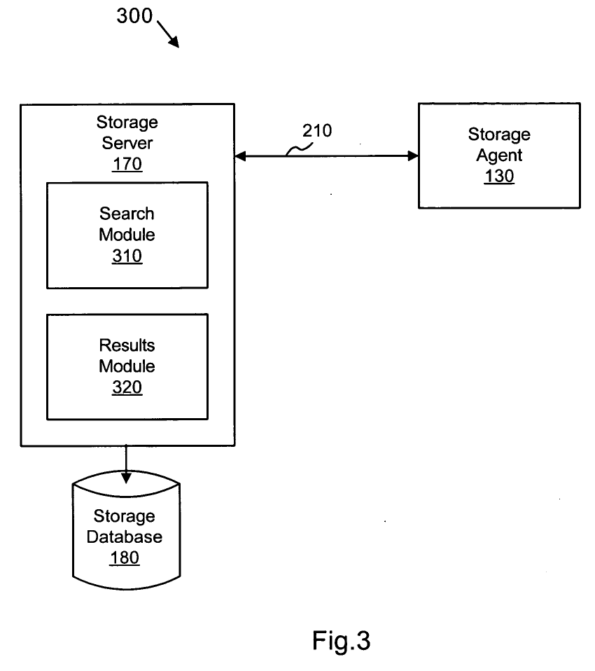

FIG. 3 depicts a schematic block diagram illustrating one embodiment of an apparatus for providing metadata from a storage database of the present invention. A networked environment 300 includes a storage server 170 connected by a LAN connection 210 to a storage agent 130. The storage server 170 includes a search module 310 and a results module 320, and is connected to a storage database 180.

The search module 310 receives a query request from the storage agent 130 via the LAN connection 210 pertaining to a data restore. The search module 310 searches the storage database 180 for information regarding the objects associated with the restore. The results module 320 aggregates information retrieved by the search module 310 from the storage database 180 pertaining to a group of the objects and sends an aggregation to the storage agent 130 via the LAN connection 210. The search module 310 continues to query the storage database 180 for metadata pertaining to remaining groups of restore objects. Upon request from the storage agent 130, the results module 320 sends additional aggregations of object metadata until information relating to all of the restore objects has been sent.

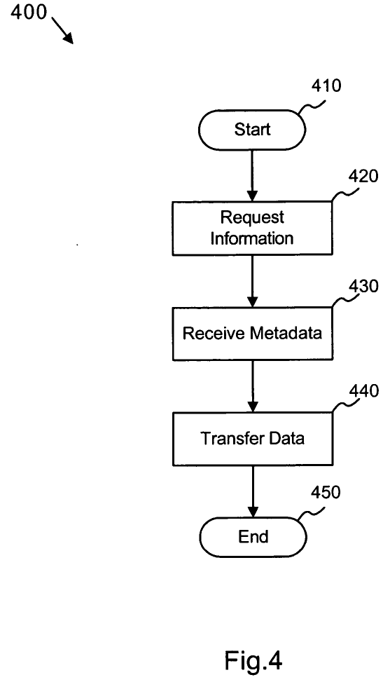

FIG. 4 depicts a schematic flow chart diagram illustrating one embodiment of a method for restoring data from a networked storage pool in accordance with the present invention. The method 400 starts 410 subsequent to a client 120 requesting a data restore and the storage server 170 identifying one or more storage volumes in the storage pool 190 pertaining to the data restore. The query module 230 requests 420 information corresponding to data objects associated with the data restore, and subsequently receives 430 an aggregation of metadata corresponding to the restore objects retrieved from a storage database 180.

The restore module 240 uses the aggregation of metadata to transfer 440 the data objects from a storage pool 190 to the client 120, which writes the data objects to a restore volume 250. The client 120 uses the metadata to construct a directory such that the data objects retain the same attributes that they formerly possessed. For example, a restored object would have the same name, the same access privileges, and the like. After the data is transferred to the restore volume 250, the method 400 ends 450.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for restoring data from a networked storage pool, the apparatus comprising:
a query module configured to request information regarding a plurality of objects associated with a restore;
the query module further configured to receive metadata corresponding to at least one of the plurality of objects, the metadata aggregated from a plurality of queries to a storage database; and
a restore module configured to transfer data corresponding to the plurality of objects from a storage pool to a client's restore volume.

2. The apparatus of claim 1, wherein the information request references a particular volume.

3. The apparatus of claim 1, wherein the information request specifies a particular restore session.

4. The apparatus of claim 1, wherein the information request is received by a storage server.

5. The apparatus of claim 1, wherein the queries to the storage database are performed by a storage server.

6. The apparatus of claim 1, wherein the metadata is selected from the group consisting of location on the media, storage attributes, file name, file size, and access rights.

7. The apparatus of claim 1, wherein the received metadata comprises an aggregate of information associated with a plurality of individual objects.

8. An apparatus for providing metadata from a storage database, the apparatus comprising:
a search module configured to receive a query request and search a storage database for information regarding a plurality of objects associated with the query request; and
a results module configured to aggregate the information derived from the search and send the information to the requester in a single communication.

9. The apparatus of claim 8, wherein the query request references a particular volume.

10. The apparatus of claim 8, wherein the query request specifies a particular restore session.

11. The apparatus of claim 8, wherein the information is metadata.

12. The apparatus of claim 11, wherein the metadata is selected from the group consisting of location on the media, storage attributes, file name, file size, and access rights.

13. The apparatus of claim 11, wherein the metadata is aggregated and sent as a single communication comprising information associated with a plurality of individual objects.

14. A system for restoring data from a networked storage pool, the system comprising:
a local area network (LAN) and a storage area network (SAN);
at least one client, the client connected to the LAN and the SAN;
a storage pool connected to the SAN, the storage pool comprising at least one storage device;
a storage server configured to provide metadata corresponding to objects stored in the storage pool; and
a storage agent configured to issue queries regarding objects associated with a restore, receive metadata corresponding to the objects from the storage management server aggregated from a plurality of queries to a storage database, and transfer data corresponding to the objects from the storage pool to a client for placement on a restore volume.

15. The system of claim 14, wherein the request refers to a particular volume and specifies a particular restore session.

16. The system of claim 14, wherein the metadata is selected from the group consisting of location on the media, storage attributes, file name, file size, and access rights.

17. A computer readable storage medium comprising computer readable code configured to carry out a method for restoring data from a networked storage pool, the method comprising:
requesting information regarding a plurality of objects associated with a restore;
receiving metadata corresponding to the objects, the metadata aggregated from a plurality of queries to a storage database; and
transferring data relating to the objects from a storage pool to a client for placement on a restore volume.

18. The computer readable storage medium of claim 17, wherein the request relates to a particular volume.

19. The computer readable storage medium of claim 17, wherein the request specifies a particular restore session.

20. The computer readable storage medium of claim 17, wherein the request is received by a storage server.

21. The computer readable storage medium of claim 17, wherein the queries to the storage database are performed by a storage server.

22. The computer readable storage medium of claim 17, wherein the metadata is selected from the group consisting of location on the media, storage attributes, file name, file size, and access rights.

23. The computer readable storage medium of claim 17, wherein metadata is sent in an aggregated communication comprising information associated with a plurality of individual objects.

24. A method for restoring data from a networked storage pool, the method comprising:
requesting information regarding a plurality of objects associated with a restore;
receiving metadata corresponding to the objects, the metadata aggregated from a plurality of queries to a storage database; and
transferring data relating to the objects from a storage pool to a client for placement on a restore volume.

25. The method of claim 24, wherein the metadata is selected from the group consisting of location on the media, storage attributes, file name, file size, and access rights.

26. An apparatus for restoring data from a networked storage pool, the apparatus comprising:
means for requesting information regarding a plurality of objects associated with a restore;
means for receiving metadata corresponding to the objects, the metadata aggregated from a plurality of queries to a storage database; and
means for transferring data relating to the objects from a storage pool to a client for placement on a restore volume.
